(19) United States
(12) Patent Application Publication
(10) Pub. No.: US 2004/0257472 A1
(43) Pub. Date: Dec. 23, 2004

(54) System, method, and apparatus for simultaneously displaying multiple video streams

(76) Inventors: Srinivasa Mpr, Bangalore (IN); Sandeep Bhatia, Bangalore (IN); Srilakshmi D., Bangalore (IN)

Correspondence Address: MCANDREWS HELD & MALLOY, LTD, 500 WEST MADISON STREET, SUITE 3400, CHICAGO, IL, 60661

(21) Appl. No.: 10/600,162

(22) Filed: Jun. 20, 2003

(51) Int. Cl. H04N 5/45

(52) U.S. Cl. 348/565

(57) ABSTRACT

Disclosed herein are system(s), method(s), and apparatus for simultaneously displaying multiple video streams. The video streams are encoded as a video sequence, which can include temporally coded bi-directional pictures. A decoder decodes a picture from each of the video sequences, which can include temporally coded bi-directional pictures. The set of frame buffers stores the past prediction frames and the future prediction frames for each video sequence. A table indicates the location of the past prediction frame and the future prediction frame for each video sequence. A display engine prepares a frame from each video sequence for display. The location of the frames for display are indicated by a register.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A useful feature in video presentation is the simultaneous display of multiple video streams. Simultaneous display of multiple video streams involves displaying the different videos streams in selected regions of a common display.

One example of simultaneous display of video data from multiple video streams is known as the picture-in-picture (PIP) feature. The PIP feature displays a primary video sequence on the display. A secondary video sequence is overlayed on the primary video sequence in significantly smaller area of the screen.

Another example of simultaneous display of video data from multiple video streams includes displaying multiple video streams recording simultaneous events. In this case, each video stream records a separate, but simultaneously occurring event. Presenting each of the video streams simultaneously allows the user to view the timing relationship between the two events.

Another example of simultaneous presentation of multiple video streams includes video streams recording the same event from different vantage points. The foregoing allows the user to view a panorama recording of the event.

One way to present multiple video streams simultaneously is by preparing the frames of the video streams for display as if displayed independently, concatenating the frames, and shrinking the frames to the size of the display. However, the foregoing increases hardware requirements. Hardware requirements have a linear relationship with the number of video streams presented. To utilize a unified architecture, wherein a single set of hardware prepares each of the frames for display, hardware is required to operate with sufficient speed to prepare each frame in one frame display period.

An additional problem occurs with video streams that are compressed using temporal coding. Temporal coding takes advantage of redundancies between successive frames. For example, a frame can be represented by an offset or a difference frame from another frame, known as a prediction frame. The offset frame or difference frame is the difference from the encoded frame and the prediction frame. Ideally, given the similarities between successive frames, the offset or difference frame will require minimal data to encode. In another example, a frame can be represented by describing the spatial displacement of various portions of the frame from a prediction frame. The foregoing is known as motion compensation.

Frames can be temporally coded from more than one other prediction frame. Additionally, frames are not limited to prediction from past frames. Frames can be predicted from future frames, as well. For example, in MPEG-2, some frames are predicted from a past prediction frame and a future prediction frame. Such frames are known as bi-directional frames.

Temporal coding creates data dependencies between the prediction frames and the temporally coded frames. During decoding, prediction frames must be decoded prior to the frames data dependent, thereon. However, wherein a temporally coded frame is predicted from a future frame, the future frame must be decoded first but displayed later. As a result, for video streams using bi-directional temporal encoding, the decode order and the display order are different. Therefore, the simultaneous display of multiple video streams cannot be achieved by concatenating and shrinking the frames decoded by the decoder during each time interval. Moreover, because each video stream can have a multitude of different data dependencies, it is likely that the frames decoded by the decoder during a particular time interval are to be displayed at different times from one another.

These and other shortcomings of conventional approaches will become apparent by comparison of such conventional approaches to the embodiments described by the following text and associated drawings.

### BRIEF SUMMARY OF THE INVENTION

Disclosed herein are system(s), method(s), and apparatus for simultaneously displaying multiple video streams. The video streams are encoded as a video sequence, which can include temporally coded bi-directional pictures. A decoder decodes a picture from each of the video sequences that can include temporally coded bi-directional pictures. The set of frame buffers stores the past prediction frames and the future prediction frames for each video sequence. A table indicates the location of the past prediction frame and the future prediction frame for each video sequence. A display engine prepares a frame from each video sequence for display. The locations of the frames for display are indicated by a register.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of a circuit for simultaneously presenting multiple video streams in accordance with an embodiment of the present invention;

FIG. 2A is a block diagram of an exemplary video stream;

FIG. 2B is a block diagram of pictures;

FIG. 2C is a block diagram of pictures in data dependent order;

FIG. 2D is a block diagram of an exemplary video sequence;

FIG. 3 is a block diagram of exemplary frame buffers in accordance with an embodiment of the present invention;

FIG. 4 is a block diagram of an table in accordance with an embodiment of the present invention;

FIG. 5 is a block diagram of an exemplary register in accordance with an embodiment of the present invention; and

FIG. 6 is a flow diagram for simultaneously displaying multiple video streams in accordance with an embodiment of the present invention.

### DETAILED DESCRIPTION OF THE INVENTION

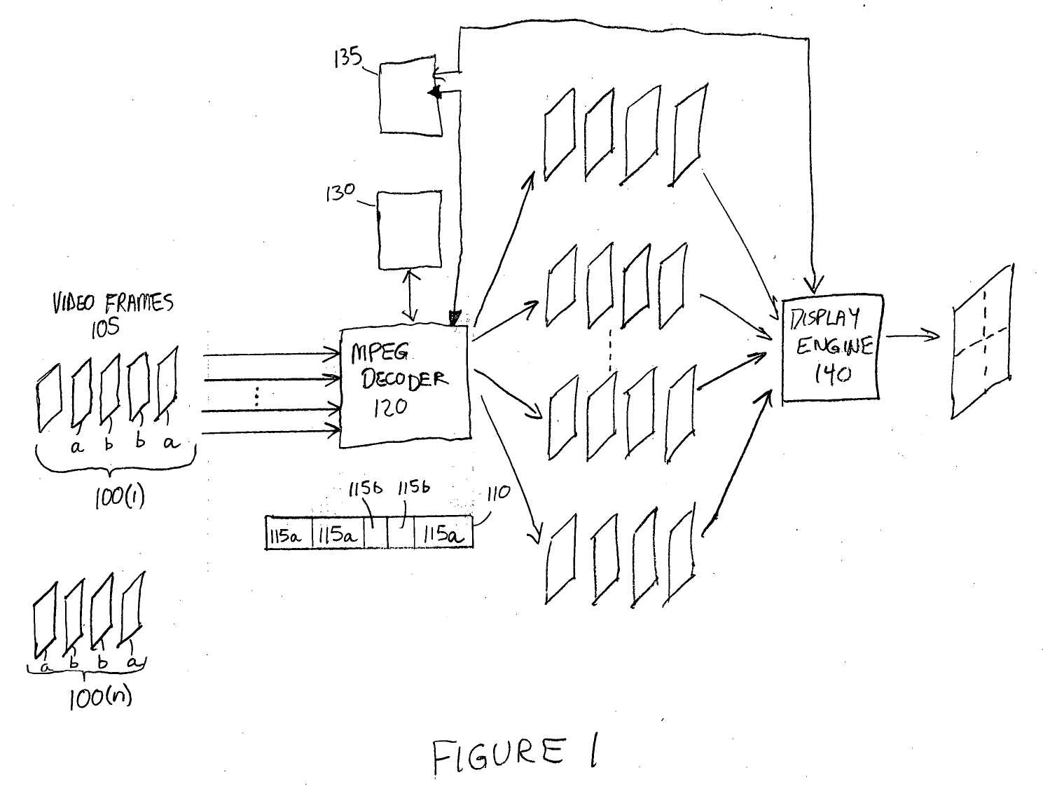

Referring now to FIG. 1, there is illustrated a block diagram describing the simultaneous presentation of multiple video streams 100 in accordance with an embodiment of the present invention. Each video stream 100 comprises a series of frames 105. In the case of interlaced displays, each frame comprises two adjacent fields.

The frames 105 of the video stream 100 are encoded in accordance with a predetermined format, thereby resulting in a video sequence 110 of compressed frames 115. The predetermined format incorporates a variety of different compression techniques, including temporal coding. Temporal coding takes advantage of redundancies between successive frames 105. As a result, many frames 105(b) can be encoded as an offset or displacement from prediction frames 105(a). The compressed frames 115(b) representing frames 105b include the offset or displacement data with respect to the prediction frames 105(a).

Frames can be temporally coded from more than one prediction frame 105(a). Additionally, frames can be predicted from future frames, as well. A compressed frame 115(b) that is temporally coded with respect to a past prediction frame 105(a), and a future prediction frame 105(a), is considered bi-directionally coded.

Each video sequence 110 comprises the compressed frames 115. The video sequences 110 are received at a decoder 120. The decoder 120 decodes the compressed frames 115, recovering frames 105′. The recovered frames 105′ are perceptually similar to corresponding frames 105. The decoder 120 has sufficient bandwidth to decode at least one frame 105 from each of the video sequences 110 per frame display period.

Because of the presence of the bi-directionally coded frames 115, the decoder 120 decodes the frames 105 in an order that is different from the display order. The decode frames 105 are stored in a memory 125. The decoder 120 decodes each prediction frames 105(a) prior to frames 105b that are predicted from the prediction frame 105(a). The decoder 120 also maintains a table 130 indicating the location of the prediction frames 105a in the memory 125 for each video sequence 110. The compressed frames 115(b) are decoded by application of the offset and/or displacement stored therein, to the prediction frames 105(a).

Additionally, although the decoder 120 decodes at least one frame 105 from each video sequence 110 per frame period, the frames 105 decoded during a frame period are not necessarily displayed during the same frame period. A table 135 is maintained that indicates the memory location of each frame 105 that is to be displayed at a particular time.

At each frame display period, a display engine 140 retrieves and concatenates each frame 105 that is to be displayed during the frame display period. The display engine 140 retrieves the appropriate frames for display by retrieving the frames indicated in the table 135. The frames 105 are concatenated, forming a multi-frame display 145, scaled, as necessary. At each frame display period, the display engine 140 provides the multi-frame display 145 for display on the display device. The series of multi-frame displays 145 represent the simultaneous display of each of the video sequences 110.

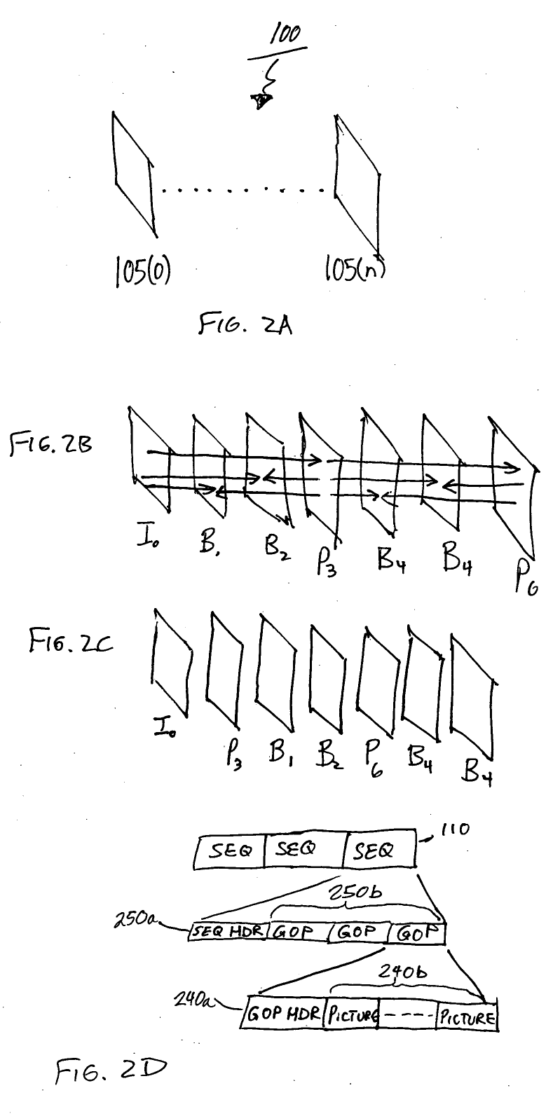

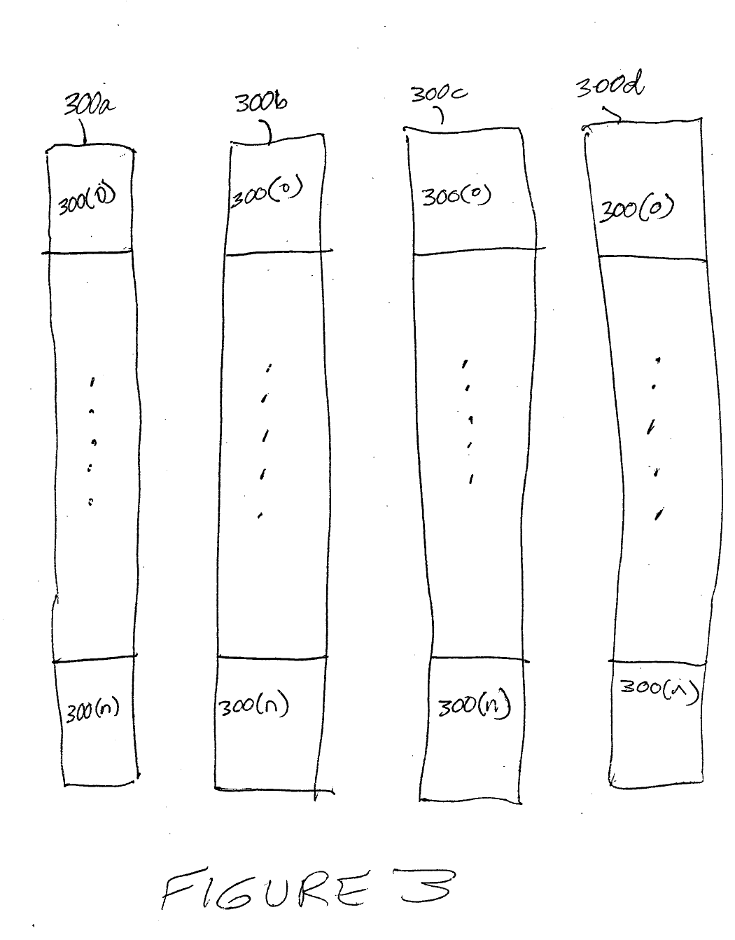

Referring now to FIG. 2A, there is illustrated a block diagram of an exemplary video stream 100. The video stream comprises frames 105(1) . . . 105(n). In some cases, the frames 105 can comprise two fields, wherein the fields are associated with adjacent time intervals.

Pursuant to MPEG-2, the frames 105(1) . . . 105(n) are encoded using algorithms taking advantage of both spatial redundancy and/or temporal redundancy. The encoded pictures are known as pictures. Referring now to FIG. 2B, there is illustrated an exemplary block diagram of pictures I₀, B₁, B₂, P₃, B₄, B₅, and P₆. The data dependence of each picture is illustrated by the arrows. For example, picture B₂ is dependent on reference pictures I₀, and P₃. Pictures coded using temporal redundancy with respect to either exclusively earlier or later pictures of the video sequence are known as predicted pictures (or P-pictures), for example picture P₃. Pictures coded using temporal redundancy with respect to earlier and later pictures of the video sequence are known as bi-directional pictures (or B-pictures), for example, pictures B₁, B₂. Pictures not coded using temporal redundancy are known as I-pictures, for example I₀. In MPEG-2, I and P-pictures are reference pictures.

The foregoing data dependency among the pictures requires decoding of certain pictures prior to others. Additionally, since in some cases a later picture is used as a reference picture for a previous picture, the later picture is decoded prior to the previous picture. As a result, the pictures are not decoded in temporal order. Accordingly, the pictures are transmitted in data dependent order. Referring now to FIG. 2C, there is illustrated a block diagram of the pictures in data dependent order.

The pictures are further divided into groups known as groups of pictures (GOP). Referring now to FIG. 2D, there is illustrated a block diagram of the MPEG hierarchy. The pictures of a GOP are encoded together in a data structure comprising a picture parameter set, which indicates the beginning of a GOP, 240a and a GOP Payload 240b. The GOP Payload 240b stores each of the pictures in the GOP in data dependent order. GOPs are further grouped together to form a video sequence 110. The video stream 100 is represented by the video sequence 110.

Referring again to FIG. 1, the decoder 120 decodes at least one picture, I₀, B₁, B₂, P₃, B₄, B₅, P₆, . . . , from each video sequence 110 during each frame display period. Due to the presence of the B-pictures, B₁, B₂, the decoder 120 decodes the pictures, I₀, B₁, B₂, P₃, B₄, B₅, P₆, . . . ,for each video sequence 110 in an order that is different from the display order. The decoder 120 decodes each of the reference pictures, e.g., I₀, P₃, prior to each picture that is predicted from the reference picture, for each video sequence 110. For example, the decoder 120 decodes I₀, B₁, B₂, P₃, in the order, I₀, P₃, B₁, and B₂. After decoding I₀ and P₃, the decoder 120 applies the offsets and displacements stored in B₁, and B₂, to decoded I₀ and P₃, to decode B₁ and B₂. In order to apply the offset contained in B₁ and B₂, to decoded I₀ and P₃, the decoder 120 stores decoded I₀ and P₃ in memory known as frame buffers.

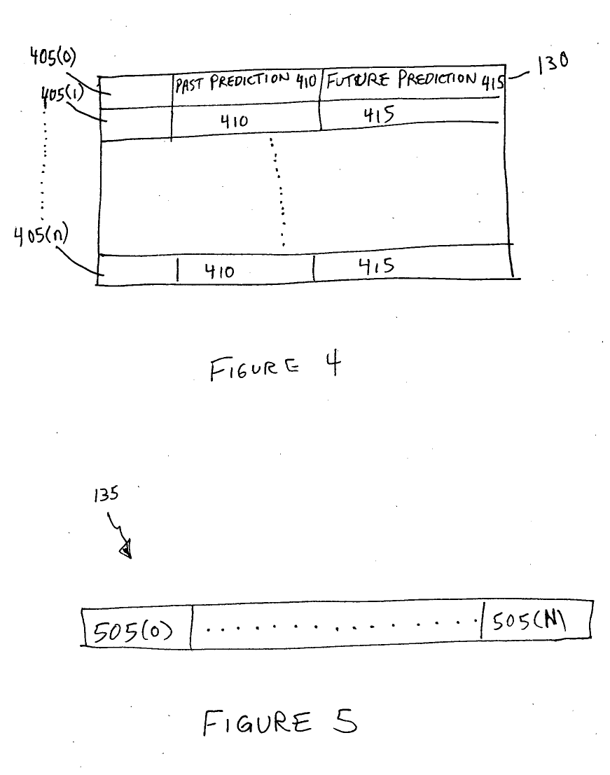

Referring now to FIG. 3, there is illustrated a block diagram of frame buffers 300 in accordance with an embodiment of the present invention. The decoder 120 writes decoded frame 105 to four frame buffers 300a, 300b, 300c, and 300d. Each frame buffer 300a, 300b, 300c, 300d further comprises a plurality of sub-frame buffers 300(0), . . . 300(n). Although the sub-frame buffers 300(0) . . . 300(n) are illustrated as both contiguous and continuous, it is noted that the sub-frame buffers 300(0) . . . 300(n) may be mapped in a variety of ways. In at least some of the ways, the sub-frame buffers 300(0) . . . 300(n) can be non-contiguous and non-continuous with respect to each other. Each video sequence 110 decoded by the decoder 120 is associated with particular ones of the sub-frame buffers 300(0) . . . 300(n) for each frame buffer 300a, 300b, 300c, and 300d. In other words, sub-frame buffers 300(0) in frame buffers 300a, 300b, 300c, and 300d are associated with a particular one of the plurality of video sequences 110, and sub-frames buffers 300(1) in frame buffers 300a, 300b, 300c, and 300d are associated with another particular one of the plurality of video sequences 110.

When the decoder 120 decodes a picture, I₀, B₁, B₂, P₃, B₄, B₅, P₆, . . . , from a particular video sequence 110, the decoder 120 writes the decoded picture, I₀, B₁, B₂, P₃, B₄, B₅, P₆, . . . , into the sub-frame buffers 300(0) . . . 300(n) associated therewith, in either frame buffer 300a, 300b, 300c, or 300d. Both decoded I-pictures and P-pictures can be either past or future prediction pictures for B-pictures and past prediction pictures for the P-pictures.

Each sub-frame buffer 300(0) . . . 300(n) of frame buffers 300a and 300b store the two most recently decoded I or P-pictures from the video sequence 110 associated therewith. The sub-frame buffers 300(0) . . . 300(n) of frame buffers 300c and 300d are used to store decoded B-pictures from the associated video sequence 110.

The sub-frame buffer 300(0) . . . 300(n) storing the most recently decoded I or P-picture for the associated video sequence 110 is a future prediction sub-frame buffer, while the sub-frame buffer 300(0) . . . 300(n) storing the second most recently decoded I or P-picture for the associated video sequence 110 is a past prediction sub-frame buffer.

When the decoder 120 decodes a new I or P-picture in a video sequence 110, the decoded I or P-picture is the future prediction frame, the initial future prediction frame becomes the past prediction frame for the video sequence 110. The decoder 120 overwrites the past prediction frame with the new future prediction frame. The sub-frame buffer 300(0) . . . 300(n) initially storing the past prediction frame stores the new future prediction picture and becomes the future prediction sub-frame buffer. The sub-frame buffer 300(0) . . . 300(n) initially storing the future prediction frame stores the past prediction frame, and becomes the past prediction sub-frame buffer.

The decoded pictures stored in the sub-frame buffers 300(0) are shown in the table below for the video sequence comprising I₀, P₃, B₁, B₂, P₆, B₄, B₅. The future prediction sub-frame buffer is indicated with an “*”.

| Decoding | 300a/300(0) | 300b/300(0) | 300c/300(0) | 300d/300(0) |
|---|---|---|---|---|
| I₀ | I₀ | | | |
| P₃ | I₀ | *P₃ | | |
| B₁ | I₀ | *P₃ | B₁ | |
| B₂ | I₀ | *P₃ | B₁ | B₂ |
| P₆ | *P₆ | P₃ | B₁ | B₂ |
| B₄ | *P₆ | P₃ | B₄ | B₂ |
| B₅ | *P₆ | P₃ | B₄ | B₅ |

As can be seen, the location of the future prediction frame and the past prediction frame changes dynamically for one video sequence 110. Additionally, the dynamic changes in the location of the future prediction frame and the past prediction frame for one video sequence 110 can be unrelated to the location of the future prediction frame and the past prediction frame for another video sequence 110. For example, the frame stored in sub-frame buffer 300(0) of frame buffer 300a can be the future prediction frame for one video sequence 110, while the frame stored in 300(1)a can be the past prediction frame for another video sequence 110. Therefore, the decoder 120 maintains a table 130 indicating the sub-frame buffer 300(0) . . . 300(N) storing the past prediction frame and the future prediction frame for each video sequence 110.

Referring now to FIG. 4, there is illustrated a block diagram of an exemplary table 130 indicating the sub-frame buffers 300(0) . . . 300(N) storing past prediction pictures and future prediction frames. The table 130 includes registers 405(0) . . . 405(N), each of which are associated with a particular one of the video sequences 110. Each register 405(0) . . . 405(N) includes past prediction frame buffer indicators 410, and a future prediction frame buffer indicators 415. The past prediction frame buffer indicator 410 stores an identifier identifying the particular frame buffer 300a or 300b comprising the sub-frame buffer. 300(0) . . . 300(N) storing the past prediction frame, while the future prediction frame indicator 415 stores an identifier identifying the particular frame buffer 300a or 300b comprising the sub-frame buffer 300(0) . . . 300(N) storing the future prediction frame.

When the decoder 120 decodes a picture, I₀, B₁, B₂, P₃, B₄, B₅, P₆, . . . , from one of the video sequences 110, the decoder 120 examines the register 405 associated with the particular video sequence 110 to determine the location of the past prediction frame and the future prediction frame. The decoder 120 then decodes the picture by applying offsets and displacements stored therein to the past and/or future prediction frame, as indicated. If the decoded picture is an I or P-picture, the decoder 120 writes the decoded frame 105 into the past prediction sub-frame buffer 300(0) . . . 300(N). Additionally, the decoder 120 updates the register 405, by swapping the past prediction frame buffer indicator 410 with the future prediction frame buffer indicator 415.

Referring again to FIG. 1, at each frame display period, a display engine 140 retrieves and concatenates the decoded frames 105 for each video sequence 110 that are to be displayed during the frame display period. The decoded frames 105 for a particular video sequence 110 can be retrieved from one of the sub-frame buffers 300(0) . . . 300(N) associated with the video sequence 110. However, frame buffer 300a, 300b, 300c, or 300d comprising the sub-frame buffers 300(0) . . . 300(N) storing the frame to be displayed for a particular video sequence 110 can vary from the different video sequences 110. Accordingly, the frame buffers 300a, 300b, 300c, or 300d storing the frame to be displayed for a particular video sequence 110 are indicated in a register 135 maintained by the decoder.

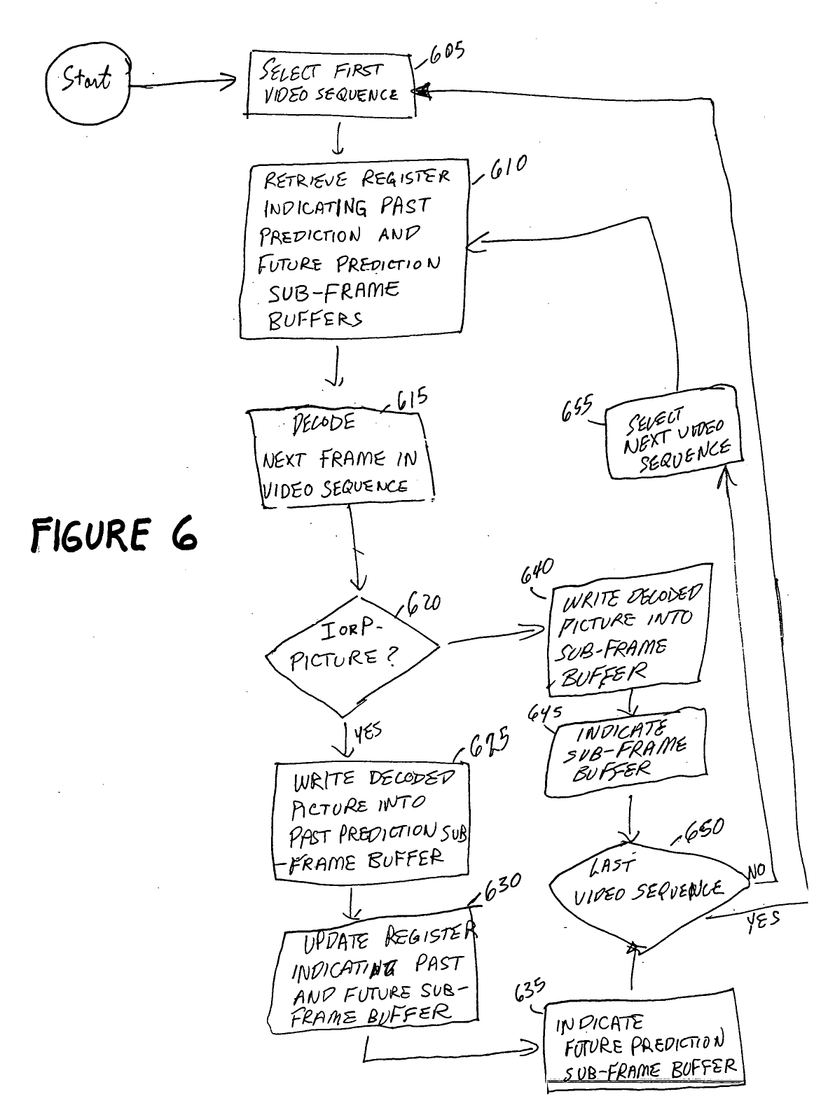

Referring now to FIG. 5, there is illustrated a block diagram of the register 135 in accordance with an embodiment of the present invention. The register 135 stores a plurality of indicators 505(0) . . . 505(N), each of said indicators associated with a particular one of the video sequences 110. The indicators 505 indicate the frame buffer 300a, 300b, 300c, or 300d comprising the sub-frame buffer 300(0) . . . 300(N) storing the frame 105 to display from the video sequence 110 associated therewith.

The display engine 140 maintains the register 135. The display engine 140 can determine the frame to be displayed for a video sequence 110, based on inputs from the decoder 120. The decoder 120 has a buffer management routine that gives the relevant inputs to the display engine 140. The display engine updates the register 135 them based on these inputs.

If the decoder 120 decodes a B-picture, the decoded B-picture is the frame to be displayed and the decoder 120 indicates the frame buffer 300a, 300b, 300c, or 300d comprising the sub-frame buffer 300(0) . . . 300(N) storing the decoded B-picture in the register 135. One the other hand, if the decoder 120 decodes an I-picture or a P-picture, the initial future prediction frame is the frame to be displayed. Accordingly, the decoder indicates the frame buffer 300a, 300b, comprising the initial future prediction sub-frame buffer 300(0) . . . 300(N).

Referring again to FIG. 1, the display engine 140 scans in each of the frames 105 indicated by the register 135, concatenates the frames 105 forming a multi-frame display 145. The series of multi-frame displays 145 represent the simultaneous display of each of the video sequences 110.

Referring now to FIG. 6, there is illustrated a flow diagram describing the operation of the decoder in accordance with an embodiment of the present invention. At 605, the video decoder 120 selects the first video sequence 110. At 610, the video decoder 120 retrieves the register 405 indicating the past prediction frame and the future prediction frame for the video sequence 110 selected during 605. At 615, the video decoder 120 decodes the next picture, I₀, B₁, B₂, P₃, B₄, B₅, P₆, . . . , in the selected video sequence 110 by applying the offset contained therein to the past prediction frame and the future prediction frame as necessary.

If at 620, the decoded picture is an I-picture or a P-picture, the decoder 120 writes (625) the decoded I-picture or P-picture in the sub-frame buffer 300(0) . . . 300(N) that initially stored the past prediction frame. At 630, the decoder 120 updates the register 405, by swapping the past prediction frame indicator 410 and the future prediction frame indicator 415.

If at 620, the picture is a B-picture, the decoder 120 writes (640) the decoded B-picture in a sub-frame buffer 300(0) . . . 300(N) of frame buffers 300c, or 300d. At 650, the decoder 120 determines whether the decoded frame 105 is from the last video sequence 110 to be displayed. If at 650 the decoded frame 105 is not from the last video sequence 110 to be displayed, the decoder selects the next video sequence at 655 and returns to 610. If at 650 the decoded frame 105 is from the last video sequence 110 to be displayed, the decoder 120 returns to 605 and selects the first video sequence 110.

The decoder system as described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein the flow diagram of FIG. 6 is implemented in firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A decoder for simultaneously displaying a plurality of video sequences, said decoder comprising:
a controller for executing a plurality of instructions;
a memory for storing the plurality of instructions, wherein said plurality of instructions cause the controller to perform operations comprising:
receiving at least one compressed frame from each of a plurality of video sequences;
locating at least a past prediction frame in a memory for each of the plurality of video sequences;
decoding the at least one compressed frame from each of the plurality of video sequences from the past prediction frame for each of the plurality of video sequences; and
indicating a new past prediction frame and a new future prediction frame for each of at least one of the plurality of video sequences.

2. The decoder of claim 1, wherein the compressed frame comprises a picture.

3. The decoder of claim 1, wherein the decoding the at least one compressed frame from each of the plurality of video sequences occurs during one frame display period.

4. The decoder of claim 1, wherein the operations further comprise:
indicating a frame to be displayed for each of the plurality of video sequences.

5. The decoder of claim 4, wherein the frame to be displayed for each of the plurality of video sequences further comprises a frame selected from a group consisting of the decoded at least one compressed frame from the video sequence, or the new past prediction frame for the video sequence.

6. A method for simultaneously displaying a plurality of video sequences, said method comprising:
receiving at least one compressed frame from each of a plurality of video sequences;
locating at least a past prediction frame in a memory for each of the plurality of video sequences;
decoding the at least one compressed frame from each of the plurality of video sequences from the past prediction frame for each of the plurality of video sequences; and
indicating a new past prediction frame and a new future prediction frame for each of at least one of the plurality of video sequences.

7. The method of claim 6, wherein the compressed frame comprises a picture.

8. The method of claim 6, wherein the decoding the at least one compressed frame from each of the plurality of video sequences occurs during one frame display period.

9. The method of claim 6, further comprising:
indicating a frame to be displayed for each of the plurality of video sequences.

10. The method of claim 9, wherein the frame to be displayed for each of the plurality of video sequences further comprises a frame selected from a group consisting of the decoded at least one compressed frame from the video sequence, or the new past prediction frame for the video sequence.

11. A circuit for simultaneously displaying a plurality of videos, said circuit comprising:
a plurality of frame buffers for each storing an frame from each of said plurality of videos;
a first register for storing a plurality of indicators, each of said plurality of indicators associated with a particular one of the plurality of videos, and wherein each of said plurality of indicators referring to a particular one of the frame buffers; and
a display engine for presenting the plurality of videos, wherein the video engine simultaneously presents a frame from each frame buffer indicated by said plurality of indicators.

12. The circuit of claim 11, wherein the plurality of videos comprises four videos and wherein the plurality of frame buffers further comprises four frame buffers.

13. The circuit of claim 11, wherein each of the plurality of frame buffers further comprise:
a plurality of sub-buffers, each of the sub-buffers for storing a particular frame from a particular one of the plurality of videos.

14. The circuit of claim 11, further comprising a decoder for decoding each of said plurality of videos.

15. The circuit of claim 14, further comprising:
a second register for storing a plurality of indicators, wherein each of the indicators are associated with a particular one of the plurality of videos, and wherein each of the indicators refer to a particular one of the buffers; and
wherein the decoder decodes a frame from a particular one of the plurality of videos by motion predicting from another frame stored in the frame buffer indicated by the indicator associated with the particular one of the plurality of videos in the second register.

16. The circuit of claim 15, further comprising:
a third register for storing a plurality of indicators, wherein each of the indicators are associated with a particular one of the plurality of videos, and wherein each of the indicators refer to a particular one of the buffers; and
wherein the decoder decodes a frame from a particular one of the plurality of videos by motion predicting from another frame stored in the frame buffer indicated by the indicator associated with the particular one of the plurality of videos in the third register.
